(19) United States
(12) Patent Application Publication
(10) Pub. No.: US 2026/0175873 A1
(43) Pub. Date: Jun. 25, 2026

(54) DETERMINING VEHICLE TRAJECTORIES BASED ON CONTROL DISTRIBUTIONS

(71) Applicant: Zoox, Inc., Foster City, CA (US)

(72) Inventors: Shakeeb Ahmad, San Mateo, CA (US); Liam Gallagher, San Francisco, CA (US); Xianan Huang, Foster City, CA (US); Marin Kobilarov, Baltimore, MD (US); Dhanushka Nirmevan Kularatne, Castro Valley, CA (US); Syed Bilal Mehdi, Newark, CA (US); Shohin Mukherjee, San Mateo, CA (US); Chonhyon Park, Sunnyvale, CA (US); Paul Benjamin Reverdy, Seattle, WA (US); Jeremy Schwartz, Redwood City, CA (US); Ke Sun, Foster City, CA (US); Mingfeng Zhang, Foster City, CA (US)

(21) Appl. No.: 18/986,915

(22) Filed: Dec. 19, 2024

(51) Int. Cl. B60W 60/00

(52) U.S. Cl. CPC B60W 60/0011; B60W 60/0023

(57) ABSTRACT

A vehicle trajectory may be determined by sampling sequences of vehicle controls based on a set of control distributions. The control distributions may then be updated based on a set of trajectory-related costs associated with the sampled trajectories. The sampled trajectories may be used to determine a trajectory for the vehicle. The determined trajectory may be used to control the vehicle and/or the vehicle's driving behavior.

### BACKGROUND

Autonomous and semi-autonomous vehicles are becoming increasingly prevalent worldwide. These vehicles are equipped with sensor systems and computing devices that enable them to navigate through their environment and make driving decisions. However, the decision-making processes employed by autonomous and semi-autonomous vehicles can sometimes result in behavior that is unexpected and/or unnatural to human drivers and pedestrians.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a pictorial flowchart diagram of an example process for determining an optimal trajectory for controlling a vehicle.

FIG. 2 is a flowchart diagram of an example process for determining trajectory-related cost(s) associated with a set of sampled scenarios.

FIG. 3 is a flowchart diagram of an example process for determining an optimal vehicle trajectory based on an iterative trajectory planning process.

FIG. 4 is a flowchart diagram of an example process for controlling a vehicle based on a selected trajectory.

FIG. 5 depicts a block diagram of an example system for implementing various techniques described herein.

### DETAILED DESCRIPTION

This disclosure describes techniques for determining a trajectory for controlling a vehicle. A trajectory may include a sequence of controls (e.g., steering, accelerating, braking, and/or the like) and/or desired states to be executed or achieved by the vehicle over time. Determining an optimal trajectory for a vehicle may include searching through a large space (e.g., a continuous space) of potential controls based on one or more cost factors. In some cases, searching through the entire space of potential controls may be computationally intractable, especially when the search is performed in real-time and/or subject to computational resource constraints.

In some cases, the techniques described herein relate to an iterative process for efficiently determining a trajectory for controlling a vehicle. The process may include determining a set of costs associated with a set of trajectories over a set of iterations. An iteration may include sampling trajectories and/or sets of controls based on a set of probability distributions defined over a trajectory space. The probability distributions may be determined based on the costs determined in a prior iteration of the process. In some cases, focusing the sampling of trajectories based on the previously determined costs enables the process to efficiently explore the trajectory space by focusing on regions that are more likely to include lower-cost trajectories. As described herein, sampling a trajectory may include sampling a control from a control distribution, sampling a sequence of controls from a set of control distributions, and/or the like.

In some cases, an example system determines a set of trajectories using a set of planning iterations. A planning iteration may include: (i) determining a set of trajectories (e.g., based on sampling from a set of control distributions and/or receiving a set), (ii) determining a set of costs associated with the set of trajectories, and/or (iii) generating a set of control distributions based on the set of costs. For example, in some cases, during an initial sampling iteration, the system: (i) receives and/or determines an initial set of trajectories (e.g., based on a set of predetermined controls and/or a set of randomly selected controls), (ii) determines a set of costs associated with the set of trajectories, and/or (iii) generates a set of control distributions (e.g., a set of distributions of controls) based on the set of costs. As another example, in some cases, during a post-initial sampling iteration after the initial sampling iteration, the system: (i) receives a set of control distributions generated in a preceding sampling iteration (e.g., in the second sampling iteration, the set of control distributions generated in the initial sampling iteration), (ii) samples a set of trajectories and/or a set of controls based on the set of control distributions, (iii) determines a set of costs associated with the sampled set of trajectories, and/or (iv) generates a new set of control distributions based on the set of costs.

In some cases, a trajectory includes a sequence of controls. A control may represent a specific action that may be performed by a computing device (e.g., a vehicle computing device) to control a vehicle traversing an environment (e.g., to cause a particular vehicle's movement). In some cases, a control represents a set of parameters that define one or more aspects (e.g., throttle, acceleration, steering, braking, and/or the like) of a proposed movement for the vehicle. In some cases, a control includes a multidimensional vector representing a set of movement features. For example, in some cases, a control may represent a particular longitudinal acceleration, a particular lateral acceleration, a particular longitudinal velocity, a particular lateral velocity, a particular steering angle, a particular lateral position, and/or a particular longitudinal position. In some cases, the sequence of controls represented by a trajectory are associated with a sequence of times (e.g., where each consecutive pair of times in the sequence may be separated by a defined time interval). For example, in some cases, a trajectory may include a first control representing a first proposed vehicle movement for controlling the vehicle at a first time, a second control representing a second proposed vehicle movement for controlling the vehicle at a second time after the first time, and/or the like. In this example, controlling the vehicle based on the described trajectory may include controlling the vehicle based on the first control at the first time, controlling the vehicle based on the second control at the second time and/or after controlling the vehicle based on the first control, and/or the like. In some cases, the sequence of times and/or controls associated with a trajectory may include H times and/or controls. H, may, for example be determined based on a predefined value, an estimated available computational complexity of the system, a trajectory planning window, and/or the like.

In some cases, the sequence of controls represented by a trajectory includes at least one of a base control and one or more contingent controls. For example, in some cases, a sequence of H controls represented by a trajectory includes a base control or controls and (H−1) contingent controls. A base control(s) may be a control represented by the trajectory and associated with an initial time (e.g., the first control in the sequence). A contingent control may be a control represented by the trajectory and associated with a post-initial time (e.g., a control in the sequence that is after the first control). In some cases, a contingent control may be a control that is executed contingent on executing the base control at the initial time and/or detecting an environment state after executing the base control. For example, in some cases, a first trajectory may be associated with executing a first base control and executing a first contingent control after executing the first base control (e.g., repeatedly executing the first contingent control for H−1 times). As another example, in some cases, a second trajectory may be associated with executing the first base control and executing a second contingent control after executing the first base control (e.g., repeatedly executing the second contingent control for H−1 times). As another example, in some cases, a third trajectory may be associated with executing the first base control and executing a third contingent control after executing the first base control (e.g., repeatedly executing the third contingent control for H−1 times). In some cases, the same base control may be associated with N_{z} different trajectories, each being associated with executing the base control and subsequently executing a respective one of N_{z} contingent trajectories (e.g., repeatedly executing the respective contingent control for H−1 times). As used herein, “executing” a control (e.g., a base and/or a contingent control) may include controlling a vehicle based on the control (e.g., based on one or more movement parameters represented by the control). An environment state may represent a state (e.g., position, orientation, velocity, acceleration, jerk, and/or the like) associated with an object in the environment, a road layout associated with the environment, a state associated with a traffic control device in the environment, and/or the like.

In some cases, the sequence of controls represented by a trajectory includes a base control followed by (H−1) instances of the same contingent control. For example, if H=10, a trajectory a₀a₁ may be associated with a sequence of controls including the base control a₀ and nine instances of the contingent control a₁ (e.g., may be associated with the following control sequence: {a₀→a₁→a₁→a₁→a₁→a₁→a₁→a₁→a₁→a₁}). In some cases, a trajectory may be associated with controlling the vehicle in accordance with the base control (e.g., a₀) at a first time (e.g., and/or at one or more first times) and subsequently controlling the vehicle in accordance with the contingent control (e.g., a₁) until the end of a predefined and/or dynamically determined window.

In some cases, determining a trajectory includes: (i) determining a base control, and/or (ii) determining a contingent control. In some cases, determining a trajectory at an initial iteration includes determining one or more control sequences (e.g., one or more base controls and/or one or more contingent controls) based on a set of initial trajectories (e.g., as described below). In some cases, determining a trajectory at a post-initial iteration includes sampling the trajectory from one or more control distributions (e.g., as described below). In some cases, sampling a trajectory includes: (i) sampling the base control based on a first control distribution (e.g., a base control distribution, for example as described below), and/or (ii) sampling the contingent control based on a second control distribution (e.g., a contingent control distribution, for example as described below). Example techniques for determining control distribution(s) and/or sampling one or more trajectories based on control distribution(s) are described below.

As described above, determining a set of trajectories may be performed using a set of planning iterations, including an initial iteration and one or more post-initial iterations. Example operations performed during an initial iteration and/or during a post-initial iteration are described below.

For example, an initial trajectory planning may include: (i) determining an initial set of trajectories, (ii) determining a set of costs associated with the initial set of trajectories, and/or (iii) determining a set of control distributions based on the set of costs.

In some cases, determining the initial set of trajectories may include: (i) determining a set of trajectories based on a set of predetermined controls, and/or (ii) determining a set of trajectories based on a set of randomly sampled controls. In some cases, a predetermined control (e.g., a predefined and/or dynamically determined control) may be a control that is determined based on a state of the vehicle environment. In some cases, the system may: (i) determine a state of the vehicle environment at a first time (e.g., a current and/or latest environment state), and/or (ii) determine (e.g., using one or more heuristics mapping the determined environment state to a set of predetermined controls) a predetermined control based on the determined state. For example, if the environment state represents that the vehicle is in a right-lane of a two-lane road and/or without any objects in the left lane, the set of predetermined controls may include a first control associated with driving straight and a second control associated with steering to the left (e.g., with a specific steering angle).

In some cases, the initial set of trajectories includes a set of trajectories determined based on a set of predetermined controls. Determining a set of trajectories based on a set of predetermined controls may, for example, include: (i) receiving the set of predetermined controls, and/or (ii) determining a set of trajectories each associating one of the predetermined controls with a sequence of H times (e.g., each representing controlling the vehicle based on one of the predetermined controls across H times, for example until the end of a predefined and/or dynamically determined horizon). For example, if the set of predetermined controls include a first control and a second control, the system may determine: (i) a first trajectory representing the control of the vehicle based on the first control across all of the H times (e.g., with a sequence of controls including H instances of the first control), and/or (ii) a second trajectory representing the control of the vehicle based on the second control across all of the H times (e.g., with a sequence of controls including H instances of the second control).

As described above, the initial set of trajectories may also include one or more randomly sampled trajectories. These randomly sampled trajectories may, for example, be determined by randomly sampling a set of control sequences from a multi-dimensional control space. The multi-dimensional control space may be associated with a set of dimensions associated with a set of control parameters (e.g., a longitudinal acceleration dimension, a lateral acceleration dimension, a longitudinal acceleration dimension, a lateral velocity dimension, a steering angle dimension, a lateral position dimension, and/or a longitudinal position dimension). The system may determine a sequence of controls based on random sampling (e.g., using uniform hypercube sampling) of point(s) from this space. For example, in some cases, the system may determine an initial trajectory associated with a sequence of H controls based on random sampling of H points from the space. As another example, in some cases, the system may determine an initial scenario associated with the sequence of H controls based on: (i) random sampling a first point and a second point from the space, and/or (ii) generating a trajectory whose control sequence represents executing a first control associated with the first sampled point (e.g., in association with an initial time) followed by executing a second control associated with the second sampled point (e.g., in association with (H−1) post-initial times).

In some cases, the set of initial trajectories (e.g., determined based on predetermined and/or randomly sampled control(s)) may enable determining an initial estimate about the distribution of controls associated with lower-cost trajectories. For example, in some cases, after determining the set of initial trajectories (e.g., using the techniques described above), the system: (i) determines a set of costs each representing a cost associated with one of the initial trajectories, and (ii) determines a set of control distribution(s) based on the set of the costs. Accordingly, the system uses predetermined controls and/or randomly sampled controls to determine a set of cost-based control distributions that may be used to sample trajectories that are more likely to be associated with a relatively lower cost. Therefore, the initial trajectories may provide a basis for focusing subsequent trajectory sampling on a subset of the control space that is more likely to contain lower-cost trajectories.

As described above, after determining a set of initial trajectories, the initial planning iteration may include determining a set of costs associated with the set of initial trajectories. In some cases, the system may determine a cost associated with a trajectory based on one or more cost factors, such as a collision cost, a safety cost, a path progression cost, a steering cost, a travel time cost, an acceleration cost, a lane position cost, and/or a comfort cost. For example, a collision cost may represent a cost associated with a probability and/or likelihood that the vehicle will collide with another object (e.g., another vehicle, a pedestrian, a structure, and/or the like) if the vehicle is controlled based on the trajectory. As another example, a path progression cost may represent a cost associated with how much progress the vehicle will make in reaching an intended destination if the vehicle is controlled based on the trajectory. As another example, comfort cost may represent a cost associated with a comfort level (e.g., of one or more passengers and/or users of the vehicle) if the vehicle is controlled based on the trajectory. Example techniques for determining costs associated with trajectories are described in U.S. Pat. No. 11,161,502, entitled “Cost-Based Path Determination” and filed on Aug. 13, 2019, and in U.S. Pat. No. 11,360,477, entitled “Trajectory Generation using Temporal Logic and Tree Search” and filed on Jun. 22, 2020, both of which are incorporated by reference herein in entirety and for all purposes.

In some cases, determining a cost associated with a trajectory may include: (i) determining an “initial cost” associated with the trajectory, and/or (ii) determining a “post-initial cost” associated with the trajectory. An initial cost associated with the trajectory may represent an estimate about a cost (e.g., a collision cost, a safety cost, a path progression cost, a steering cost, a travel time cost, an acceleration cost, a lane position cost, and/or a comfort cost) associated with executing the trajectory's base control at an initial time. A post-initial cost associated with the trajectory may represent an estimate about a cost (e.g., a collision cost, a safety cost, a path progression cost, a steering cost, a travel time cost, an acceleration cost, a lane position cost, and/or a comfort cost) associated with executing the trajectory's contingent control at one or more post-initial times (e.g., until the end of a predefined and/or dynamically determined window).

In some cases, determining a cost associated with a trajectory includes: (i) determining a base cost based on the trajectory's base control and a set of contingent controls associated with the base control, and/or (ii) determining a contingent cost based on the trajectory's base control and the trajectory's contingent control. The base cost may represent a combination of the initial cost associated with the trajectory's base control and a measure of the post-initial costs associated with all of the trajectories that are contingent on that base control. The contingent cost may represent a combination of the initial cost and the post-initial cost associated with the particular trajectory.

For example, a base control

$${a}_{0}^{( 1 )}$$

may be associated with the trajectory

$${a}_{0}^{( 1 )} {a}_{1}^{( 1 , 1 )}$$

(e.g., a trajectory associated with the base control

$${a}_{0}^{( 1 )}$$

and the contingent control

$${a}_{1}^{( 1 , 1 )} ) ,$$

the trajectory

$${a}_{0}^{( 1 )} {a}_{1}^{( 1 , 2 )}$$

(e.g., a trajectory associated with the base control

$${a}_{0}^{( 1 )}$$

and the contingent control

$${a}_{1}^{( 1 , 2 )} ) ,$$

and the trajectory

$${a}_{0}^{( 1 )} {a}_{1}^{( 1 , 3 )}$$

(e.g., a trajectory associated with the base control

$${a}_{0}^{( 1 )}$$

and the contingent control

$${a}_{1}^{( 1 , 3 )} ) .$$

In this example, the trajectory

$${a}_{0}^{( 1 )} {a}_{1}^{( 1 , 1 )}$$

may be associated with: (i) a base cost that is determined based on a cost associated with

$${a}_{0}^{( 1 )} ,$$

a cost associated with

$${a}_{1}^{( 1 , 1 )} ,$$

a cost associated with

$${a}_{1}^{( 1 , 2 )} ,$$

and a cost associated with

$${a}_{1}^{( 1 , 3 )} ,$$

and (ii) a contingent cost determined based on a cost associated with

$${a}_{0}^{( 1 )}$$

and a cost associated with

$${a}_{1}^{( 1 , 1 )} .$$

Additionally or alternatively, the trajectory

$${a}_{0}^{( 1 )} {a}_{1}^{( 1 , 2 )}$$

may be associated with: (i) a base cost that is determined based on a cost associated with

$${a}_{0}^{( 1 )} ,$$

a cost associated with

$${a}_{1}^{( 1 , 1 )} ,$$

a cost associated with

$${a}_{1}^{( 1 , 2 )} ,$$

and a cost associated with

$${a}_{1}^{( 1 , 3 )} ,$$

and (ii) a contingent cost determined based on a cost associated with

$${a}_{0}^{( 1 )}$$

and a cost associated with

$${a}_{1}^{( 1 , 2 )} .$$

Additionally or alternatively, the trajectory

$${a}_{0}^{( 1 )} {a}_{1}^{( 1 , 3 )}$$

may be associated with: (i) a base cost that is determined based on a cost associated with

$${a}_{0}^{( 1 )} ,$$

a cost associated with

$${a}_{1}^{( 1 , 1 )} ,$$

a cost associated with

$${a}_{1}^{( 1 , 2 )} ,$$

and a cost associated with

$${a}_{1}^{( 1 , 3 )} ,$$

and (ii) a contingent cost determined based on a cost associated with

$${a}_{0}^{( 1 )}$$

and a cost associated with

$${a}_{1}^{( 1 , 3 )} .$$

In some cases, the base costs associated with these three trajectories may be the same, because they all share the same base control.

In some cases, given a set of N_{z} trajectories associated with a common base control

$${a}_{0}^{( j )} ,$$

where each kth trajectory of the N_{z} trajectories is associated with the contingent base control

$${a}_{1}^{( j , k )}$$

(e.g., where k=1, . . . , N_{z}), then the kth trajectory may be associated with: (i) a base cost Jⱼ that is determined based on

$${J}_{j} = {c}_{0}^{( j )} + σ ( {c}_{1}^{( j , k )} )$$

(e.g., where

$${c}_{0}^{( j )}$$

is the initial cost associated with the common base control

$${a}_{0}^{( j )} and / or σ ( {c}_{1}^{( j , k )} )$$

is a statistic (e.g., a Conditional Value at Risk (CVaR)) determined based on the N_{z} post-initial costs associated with the N_{z} trajectories), and/or (ii) a contingent cost J_{j,k} that is determined based on

$${J}_{j , k} = {c}_{0}^{( j )} + σ ( {c}_{1}^{( j , k )} )$$

(e.g., where

$${c}_{0}^{( j )}$$

is the initial cost associated with the common base control

$${a}_{0}^{( j )} and / or {c}_{1}^{( j , k )}$$

is the post-initial cost associated with

$${a}_{1}^{( j , k )} ) .$$

Accordingly, in same cases, the base cost may be shared across all of the N_{z} trajectories associated with a common base control

$${a}_{0}^{( j )} ,$$

while the contingent cost may be different across those trajectories. As described above, after determining a set of costs associated with a set of initial trajectories, the initial planning iteration may include determining a set of control distributions based on the set of initial costs. Examples of control distributions and example techniques for determining control distributions based on costs are described below.

In some cases, given a set of M trajectories (e.g., M initial trajectories in an initial planning iteration, M sampled trajectories in a post-initial planning iteration, and/or the like), the system determines M sets of costs each associated with one of those M trajectories using up to M parallel processes. For example, the system may include M processing units (e.g., M processors, M processing cores within a processor, and/or M threads within a processing core) and assign each of the M trajectories to a different one of the M processing units. Each processing unit may determine the set of costs associated with a respective trajectory independently and/or in parallel (e.g., substantially simultaneously) with the other processing units. In some cases, given C different sets of trajectories each associated with a respective base control of C base controls (e.g., where each of those C trajectory sets may include the respective base control and one of N_{z} contingent controls), the system may determine the cost(s) associated with each of the C trajectory sets using a respective one of up to C parallel processes. For example, the system may include C processing units (e.g., C processors, C processing cores within a processor, and/or C threads within a processing core) and assign each of the C trajectory sets to a different one of the C processing units. Each processing unit may determine the set of costs associated with a respective trajectory set independently and/or in parallel with the other processing units.

Accordingly, in some cases, during the initial planning iteration, the system determines a set of initial trajectories (e.g., using the techniques described above) and determines one or more costs (e.g., a base cost and/or a contingent cost) for each of the determined initial trajectories (e.g., using the techniques described below). After determining the costs, the system determines a set of control distributions based on those costs. Examples of control distributions and/or example techniques for determining (e.g., generating and/or updating) control distributions based on trajectory-related costs are described below.

A control distribution may be a probability distribution (e.g., a Gaussian probability) associated with a set of controls (e.g., representing probabilities and/or probability densities associated with a set of controls). In some cases, a set of control distributions include a “base distribution” and/or one or more “contingent distributions.” A base distribution may represent a probability distribution associated with selecting a base control at an initial time (e.g., a control probability conditioned on a particular environment state associated with the initial time). An example of a base distribution is q₀(a₀|b₀,v₀) (also represented herein as q₀(a₀) and q₀(a₀|v₀)), where do may represent a random variable associated with a base control, b₀ is the environment state (e.g., the detected environment state) associated with the initial time (e.g., with the time t₀), and v₀ represents the parameter(s) (e.g., a mean and/or a covariance matrix) associated with the distribution. A control distribution (e.g., a base and/or contingent distribution) may represent the probability of selecting a particular control (e.g., conditioned on one or more factors, such as one or more past controls and/or states). While various implementation of the techniques disclosed herein are described with reference to a distribution associated with one or more dimensions associated with one or more control parameters (e.g., as described above), a person of ordinary skill in the relevant technology will recognize that the techniques described herein may be performed using other distributions (e.g., a distribution of any trajectory-related parameters). For example, a distribution sampled from and/or updated in accordance with the techniques disclosed herein may be associated with one or more dimensions associated with one or more control parameters, one or more dimensions associated with one or more environment state features, one or more dimensions associated with one or more vehicle state features, and/or one or more dimensions associated with one or more target (e.g., desired) state features (e.g., target velocities, target positions, and/or the like). For example, in some cases, a control distribution may represent a joint probability distribution over both control parameters and environment state features. In some cases, sampling from such a control distribution may result in a set of control parameters, a set of environment state features, a set of vehicle state features, and/or a set of target state features. Examples of environment state features include features representing a road network and/or a weather condition of an environment, as well as features representing states (e.g., positions, orientations, movement patterns such as velocities, classifications, and/or the like) of one or more objects in the environment. Example of vehicle state features includes a position, an orientation, a movement pattern (e.g., velocity, acceleration, jerk, and/or the like), a steering angle, a throttle, a fuel level, a battery charge, a braking level, and/or the like. Examples of target state features include a target velocity, a target acceleration, a target position, a target heading, a target time of arrival, a target safety score, a target energy efficiency, and/or the like.

A contingent distribution may represent a probability distribution associated with selecting a post-initial action at a post-initial time and/or contingent on executing a particular action at an initial time. For example, a contingent distribution may represent a probability distribution associated with (e.g., conditioned on) an environment state associated with the initial time, selecting a base control in relation to the initial time, and/or determining (e.g., predicting) a particular environment state associated with the post-initial time. An example of a contingent distribution is

$${q}_{1 \vert 0} ( {a}_{1} \vert {a}_{0}^{( j )} , {b}_{1}^{1} , {v}_{1} )$$

(also represented herein as

$${q}_{1 \vert 0} ( {a}_{1} \vert {a}_{0}^{( j )} ) ) ,$$

where a₁ may represent a random variable associated with a contingent control

$${b}_{1}^{1}$$

is an environment state (e.g., the predicted environment state) associated with the post-initial time (e.g., with the time t₁) after executing a particular base action

$${a}_{0}^{( j )} ,$$

and v₁ represents the parameter(s) (e.g., a mean and/or a covariance matrix) associated with the distribution. While various implementations of the techniques disclosed herein are described with reference to a set of distributions (e.g., control distributions) including a base distribution and one or more contingent distributions (e.g., N_{z} contingent distributions), a person of ordinary skill in the relevant technology will recognize that other arrangements are possible and within the scope of these techniques. For example, in some cases, the set of distributions may include a single distribution, such as a single distribution with a first set of dimensions associated with feature(s) of a base control, as well as one or more second sets of dimensions each set associated with feature(s) of a respective one of the one or more contingent controls. In some cases, a distribution is used to sample a base control and N_{z} contingent controls collectively and as one sampled value. This distribution may be associated with a set of dimensions related to feature(s) of the base control and N_{z} sets of dimensions. Each of the N_{z} sets of dimensions may be related to feature(s) of one of the N_{z} contingent controls.

In some cases, determining a set of control distributions at a particular planning iteration includes: (i) determining a base distribution, and/or (ii) determining N_{z} contingent distributions (e.g., where N_{z}≥1). N_{z} may represent a number of predicted states associated with a post-initial time (e.g., a time t₀) that the system uses to condition contingent distribution. For example, if N_{z}=3, the system may: (i) sample a base control

$${a}_{0}^{( j )}$$

from a base distribution q₀(a₀) associated with an initial time t₀, (ii) determine N_{z}=3 different environment states

$$( i . e . , {b}_{1}^{( j , k )} for k = 1 , … , {N}_{z} )$$

predicted to occur in a post-initial time t₁ after executing

$${a}_{0}^{( j )}$$

as t₀, and (iii) determine N_{z}=3 different contingency distributions

$$( i . e . , {q}_{1 \vert 0}^{( k )} ( {a}_{1}^{( j , k )} \vert {a}_{0}^{( j )} ) for k = 1 , … , {N}_{z} ) )$$

each conditioned on one of the N_{z}=3 predicted environment states. For example, the three contingent distributions may include:

$${q}_{1 \vert 0}^{( 1 )} ( {a}_{1}^{( j , 1 )} \vert {a}_{0}^{( j )} ) , \qquad ( i )$$

which is conditioned on executing

$${a}_{0}^{( j )}$$

at t₀ and/or occurrence of

$${b}_{1}^{( j , 1 )}$$

at t₁,

$${q}_{1 \vert 0}^{( 2 )} ( {a}_{0}^{( j , 2 )} \vert {a}_{0}^{( j )} ) , \qquad ( ii )$$

which is conditioned on executing

$${a}_{0}^{( j )}$$

at t₀ and/or occurrences of

$${b}_{1}^{( j , 2 )}$$

at t₁, and

$${q}_{1 \vert 0}^{( 3 )} ( {a}_{0}^{( j , 3 )} \vert {a}_{0}^{( j )} ) , \qquad ( ii )$$

which is conditioned on executing

$${a}_{0}^{( j )}$$

at t₀ and/or occurrence of

$${b}_{1}^{( j , 3 )}$$

at t₁. Here, such notations may represent the following:
a is an action with a subscript indicative of a where in a sequence of time steps the action occurs (e.g., 0 indicative of a base action) and a superscript j indicative of the action being a j-th action sample and optional second superscript indicative of being taken from the k-th belief,
b is a belief having a subscript indicative where in a sequence of time steps the belief occurs and a first superscript indicative of the j-th action from which the belief is determined and a second superscript indicating it is the k-th observation sample,
z is a measurement/observation having a subscript indicative of the time step and a superscript indicative of the k-th observation,
q_{1|0}^{k} represents a contingent distribution (i.e., the distribution at time sequence 1 given the 0^{th} distribution) for the k-th observation sample, and
likewise for remaining terms.

In some cases, determining a base distribution based on a set of costs associated with a set of trajectories includes: (i) determining a subset of the trajectories based on the costs (e.g., based on the base costs associated with the trajectory), and/or (ii) determining parameters of a distribution (e.g., a Gaussian distribution) that increases and/or maximizes a likelihood measure (e.g., a log likelihood) associated with the base control(s) of the trajector(ies) in the determined subset. The subset may, for example, include a ratio of (e.g., lowest-cost ten percent) of trajectories as determined based on the costs (e.g., the base costs). In some cases, determining a base distribution based on a set of costs associated with a set of trajectories includes: (i) determining a weight associated with each of the evaluated trajectories based on the cost(s) associated with the trajectory (e.g., based on the base costs associated with the trajectory), and/or (ii) determining a parameters of a distribution (e.g., a Gaussian distribution) that increases and/or maximizes a combination (e.g., a sum) of the weighted likelihood measure(s) (e.g., the weighted log likelihood(s)) of the associated base control(s).

For example, in some cases, given a set of M trajectories associated with M costs, parameter(s) of a base distribution may be determined based on the following equation:

$${v}_{0} = {arg max}_{{v}_{0}} {\sum }_{j = 1}^{M} log {q}_{0} ( {a}_{0}^{( j )} \vert {v}_{0} ) \cdot w ( {J}_{j} ) .$$

In this equation, j may iterate over the M trajectories (e.g., where M be one or more),

$${a}_{0}^{( j )}$$

may be the jth base control associated with the jth trajectory,

$${q}_{0} ( {a}_{0}^{( j )} \vert {v}_{0} )$$

may be the probability of

$${a}_{0}^{( j )}$$

conditioned on a distribution with the parameter(s) v₀, Jⱼ may be a cost (e.g., the base cost) associated with the jth trajectory (e.g., as determined based on the base cost associated with the base control and/or a combination of the N_{z} contingent costs associated with that base control), and w(Jⱼ) is a weight associated with the jth trajectory as determined based on Jⱼ. In some cases, w(Jⱼ) equals a first value (e.g., one) if Jⱼ is less than a threshold and a second value (e.g., zero) if Jⱼ equals or exceeds the threshold. The threshold may, for example, be a particular p-level quantile of the M trajectories as determined based on the associated base costs (e.g., based on p=0.1). In some cases, w(Jⱼ) is inversely proportional to Jⱼ (e.g., using an exponentially-tiled relationship and/or reward-weighted regression). For example, in some cases, w(Jⱼ)∝e^{-λ}^{ₗ}^{[J}^{ⱼ}^{-Ĵ}^{ₗ}^{]}, where λₗ is a weighting factor specific to the lth planning iteration (e.g., as determined based on the inverse of the maximum base cost of the base costs determined at the lth iteration), and Ĵₗ is a baseline cost (e.g., the minimum of the base costs determined across all iterations up to and/or including the lth iteration).

In some cases, to determine a contingent distribution based on a set of costs associated with a set of trajectories, the system performs the following operations: (i) determining a subset of the trajectories based on the costs (e.g., based on contingent costs), and/or (ii) determining parameters of a distribution (e.g., a Gaussian distribution) that increases and/or maximizes a likelihood measure (e.g., a log likelihood) associated with the contingent control(s) of the trajector(ies) in the determined subset. The subset may, for example, include a ratio of (e.g., lowest-cost ten percent) of trajectories as determined based on the costs (e.g., based on contingent costs). In some cases, determining a contingent distribution based on a set of costs (e.g., contingent costs) associated with a set of trajectories includes: (i) determining a weight associated with each of the evaluated trajectories based on a cost (e.g., a contingent cost) associated with the trajectory, and/or (ii) determining parameters of a distribution (e.g., a Gaussian distribution) that increases and/or maximizes a combination (e.g., a sum) of the weighted likelihood measure(s) (e.g., the weighted log likelihood(s)) of the associated contingent control(s).

In some cases, given a set of M trajectories associated with M costs (e.g., where M may be one or more), the system may determine parameter(s) of N_{z} contingent distributions. For example, to determine the parameter(s) of a kth contingent distribution based on the following equation:

$${v}_{1 \vert 0}^{( k )} = {arg max}_{{v}_{1 \vert 0}^{( k )}} {\sum }_{j = 1}^{M} log {q}_{1 \vert 0}^{( k )} ( {a}_{1}^{( j , k )} \vert {v}_{1 \vert 0}^{( k )} ) \cdot w ( {J}_{j , k} ) .$$

In this equation, j may iterate over the M trajectories, k may iterate over the N_{z} contingent distributions associated with a base control

$${a}_{0}^{( j )} , {a}_{1}^{( j , k )}$$

may be the kth contingent control sampled from the kth contingent distribution associated with

$${a}_{0}^{( j )} , {q}_{1 \vert 0}^{( k )} ( {a}_{1}^{( j , k )} \vert {v}_{1 \vert 0}^{( k )} )$$

may the probability of

$${a}_{1}^{( j , k )}$$

conditioned on a distribution with the parameter(s)

$${v}_{1 \vert 0}^{( k )} , {J}_{j , k}$$

may be a cost (e.g., a contingent cost) associated with the trajectory

$${a}_{0}^{( j )} {a}_{1}^{( j , k )}$$

(e.g., with a sequence of controls including

$${a}_{0}^{( j )}$$

as the base control and one or more instances of

$${a}_{1}^{( j , k )}$$

as the contingent control), and w(J_{j,k}) is a weight associated with the jth trajectory as determined based on J_{j,k}. In some cases, w(J_{j,k}) equals a first value (e.g., one) if J_{j,k} is less than a threshold and a second value (e.g., zero) if J_{j,k} equals or exceeds the threshold. The threshold may, for example, be a particular p-level quantile of the M trajectories as determined based on the associated costs (e.g., based on p=0.1). In some cases, w(J_{j,k}) is inversely proportional to J_{j,k} (e.g., using an exponentially-tiled relationship and/or reward-weighted regression). For example, in some cases, w(J_{j,k})∝e^{-λ}^{ₗ}^{[J}^{_{j,k}}^{-Ĵ}^{ₗ}^{]}, where λₗ is a weighting factor specific to the lth planning iteration (e.g., as determined based on the inverse of the maximum cost of the costs determined at the lth iteration), and Ĵₗ is a baseline cost (e.g., the minimum of the costs determined across all iterations up to and including the lth iteration).

Accordingly, in some cases, during the initial planning iteration, the system determines a set of control distributions (e.g., a base distribution and/or N_{z} contingent distributions) based on the cost(s) associated with a set of initial costs. The system may then provide the determined set of control distributions to a subsequent iteration, for example to a first post-initial iteration.

A post-initial planning iteration may include: (i) receiving a set of control distributions (e.g., determined by a previous iteration), (ii) sampling a set of trajectories (e.g., a set of controls) based on the set of control distributions, (iii) determining a set of costs associated with the sampled set of trajectories, and/or (iv) determining a new set of control distributions based on the determined cost(s). Example techniques for determining cost(s) and determining control distribution(s) based on cost(s) are described above in relation to the initial iteration and the set of initial trajectories determined in the initial iteration. Those example techniques may be used in relation to a post-initial iteration and sampled trajector(ies) determined in a post-initial iteration. To determine the sampled trajector(ies) based on a set of control distributions (e.g., determined by a previous iteration), the system may use at least one of the techniques described below.

In some cases, to sample a set of N_{z} trajectories based on a set of control distributions, the system: (i) receives the set of control distributions including a base distribution and N_{z} contingent distributions, (ii) samples a base control based on the base distribution, (iii) samples N_{z} contingent controls based on a respective one of the N_{z} contingent distributions and conditioned on execution of the sampled base control, and/or (iv) determines N_{z} trajectories each including the base control and a respective one of the N_{z} sampled contingent controls.

For example, in an (l+1)th iteration, the system may receive parameter(s) of a base distribution generated in the lth iteration (e.g., the v₀ generated at the lth iteration, which may be denoted as v_{0,l}) and parameter(s) of each of N_{z} contingent distributions (e.g., each

$${v}_{1 \vert 0}^{( k )}$$

generated at the lth iteration, which may be denoted as

$${v}_{1 \vert 0 , l}^{( k )} ,$$

for k=1, . . . , N_{z}). The system may then sample a base control

$${a}_{0}^{( j )}$$

based on

$${q}_{0} ( {a}_{0}^{( j )} \vert {v}_{0 , l} ) .$$

The sample may then sample each kth contingent action based on a

$${q}_{1 \vert 0}^{( k )} ( {a}_{1}^{( j , k )} \vert {v}_{1 \vert 0}^{( k )} ) .$$

For example, if N_{z}=3, the system may determine: (i) a first contingent action

$${a}_{1}^{( j , 1 )}$$

based on

$${q}_{1 \vert 0}^{( 1 )} ( {a}_{1}^{( j , 1 )} \vert {v}_{1 \vert 0}^{( 1 )} ) ,$$

(iii) a second contingent action

$${a}_{1}^{( j , 2 )}$$

based on

$${q}_{1 \vert 0}^{( 2 )} ( {a}_{1}^{( j , 2 )} \vert {v}_{1 \vert 0}^{( 2 )} ) ,$$

and (iii) a third contingent action

$${a}_{1}^{( j , 3 )}$$

based on

$${q}_{1 \vert 0}^{( 3 )} ( {a}_{1}^{( j , 3 )} \vert {v}_{1 \vert 0}^{( 3 )} ) .$$

Accordingly, in some cases, the system determines a set of costs associated with a set of trajectories using L planning iterations, including an initial iteration and (L−1) post-initial iteration. In some cases, in the initial iteration, the system determines a set of initial trajectories, determines a cost for each initial trajectory, and determines a base distribution and N_{z} contingent distributions based on the determined costs. The base trajectory and N_{z} contingent trajectories may represent a distribution of base and/or contingent controls that is focused on a lower-cost portion of a multi-dimensional control space. In some cases, during a post-initial iteration, the system samples a set of trajectories based on the base trajectory and N_{z} contingent trajectories generated during a prior iteration. The system may then determine a cost for each sampled trajectory, and determine a new base distribution and N_{z} new contingent distributions based on the determined costs. The new base distribution and/or the new contingent distributions may represent a distribution of base and/or contingent controls that is focused on a lower-cost portion of a multi-dimensional control space.

Accordingly, the iterative process described above may enable the system to determine costs associated with a set of trajectories while iteratively focusing the sampling of trajectories on lower-cost regions of the control space. In some cases, the iterative process may enable the system to efficiently explore the control space to determine an optimal trajectory for controlling the vehicle. In some cases, the system may determine a trajectory to use for controlling the vehicle based on the costs of a set of trajectories determined over L planning iterations. For example, in some cases, the system may select the trajectory with the lowest cost from among all trajectories determined during the L planning iterations. As another example, in some cases, the system may select a trajectory that satisfies a set of cost criteria (e.g., that is associated with a comfort cost that is below a comfort cost threshold, a safety cost that is above a safety cost threshold, and/or a collision cost that is below a collision cost threshold) from among all trajectories determined during the Z planning iterations. As yet another example, in some cases, the system may determine a weighted combination of the trajectories based on the costs of the trajectories (e.g., with lower-cost trajectories weighted higher than higher-cost trajectories).

In some cases, the system may control the vehicle based on the determined trajectory. For example, in some cases, the system may: (i) determine a set of controls associated with the determined trajectory (e.g., a base control and one or more contingent controls associated with the trajectory), and/or (ii) control the vehicle using the determined set of controls. Controlling the vehicle using the set of controls may include: (i) controlling, at an initial time associated with the base control, the vehicle according to the trajectory's base control (e.g., accelerating, decelerating, and/or steering the vehicle based on the base control), and/or (ii) controlling, at one or more post-initial times after the initial time and associated with the one or more contingent controls, the vehicle according to the contingent control(s) (e.g., accelerating, decelerating, and/or steering the vehicle based on the one or more contingent controls).

For example (e.g., given L=3 planning iterations, M=2 base control selections at each iteration, and N_{z}=3 contingent control selections associated with each selected base control), the system may determine a set of costs associated with a set of trajectories. In the initial iteration (l=1), the system may: (i) determine (e.g., based on predetermined control(s) and/or randomly sampled control(s)) two base controls

$${a}_{0}^{1} and {a}_{0}^{2} ,$$

(ii) determine three contingent controls

$${a}_{1}^{( 1 , 1 )} , {a}_{1}^{( 1 , 2 )} , and {a}_{1}^{( 1 , 3 )}$$

associated with

$${a}_{0}^{1}$$

(e.g., if

$${a}_{0}^{1}$$

is in a set of predetermined controls,

$${a}_{0}^{1} = {a}_{1}^{( 1 , 1 )} = {a}_{1}^{( 1 , 2 )} = {a}_{1}^{( 1 , 3 )} ) ,$$

(iii) determine three contingent

$${a}_{1}^{( 2 , 1 )} , {a}_{1}^{( 2 , 2 )} , and {a}_{1}^{( 2 , 3 )}$$

associated with

$${a}_{0}^{2}$$

(e.g., if

$${a}_{0}^{2}$$

is in a set of predetermined controls,

$${a}_{0}^{2} = {a}_{1}^{( 2 , 1 )} = {a}_{1}^{( 2 , 2 )} = {a}_{1}^{( 2 , 3 )} ) ,$$

(iv) determine trajectories

$${a}_{0}^{1} {a}_{1}^{( 1 , 1 )} , {a}_{0}^{1} {a}_{1}^{( 1 , 2 )} , {a}_{0}^{1} {a}_{1}^{( 1 , 3 )} , {a}_{0}^{2} {a}_{1}^{( 2 , 1 )} , {a}_{0}^{2} {a}_{1}^{( 2 , 2 )} , and {a}_{0}^{2} {a}_{1}^{( 2 , 3 )} ,$$

(v) determine costs associated with those trajectories, and/or (vi) determine, based on the determined costs, a base distribution parameter set v_{0,1} and three contingent distributions

$${v}_{1 \vert 0 , 1}^{( 1 )} , {v}_{1 \vert 0 , 1}^{( 2 )} , and {v}_{1 \vert 0 , 1}^{( 3 )} .$$

In the first post-initial iteration (l=2), the system: (i) samples two base controls

$${a}_{0}^{3} and {a}_{0}^{4}$$

based on q₀(a₀|v_{0,1}), (iii) samples three contingent controls

$${a}_{1}^{( 3 , 1 )} , {a}_{1}^{( 3 , 2 )} , and {a}_{1}^{( 3 , 3 )}$$

based on

$${q}_{1 \vert 0}^{( 1 )} ( {a}_{1}^{( 3 , 1 )} \vert {a}_{0}^{3} , {v}_{1 \vert 0 , 1}^{( 1 )} ) , {q}_{1 \vert 0}^{( 2 )} ( {a}_{1}^{( 3 , 2 )} \vert {a}_{0}^{3} , {v}_{1 \vert 0.1}^{( 2 )} ) , and {q}_{1 \vert 0}^{( 3 )} ( {a}_{1}^{( 3 , 3 )} \vert {a}_{0}^{3} , {v}_{1 \vert 0 , 1}^{( 3 )} )$$

respectively, (iv) samples three contingent controls

$${a}_{1}^{( 4 , 1 )} , {a}_{1}^{( 4 , 2 )} , and {a}_{1}^{( 4 , 3 )}$$

based on

$${q}_{1 \vert 0}^{( 1 )} ( {a}_{1}^{( 4 , 1 )} \vert {a}_{0}^{4} , {v}_{1 \vert 0 , 1}^{( 2 )} ) , {q}_{1 \vert 0}^{( 2 )} ( {a}_{1}^{( 4 , 2 )} \vert {a}_{0}^{4} , {v}_{1 \vert 0 , 1}^{( 2 )} ) , and {q}_{1 \vert 0}^{( 3 )} ( {a}_{1}^{( 4 , 3 )} \vert {a}_{0}^{4} , {v}_{1 \vert 0 , 1}^{( 2 )} )$$

respectively, (v) determines trajectories

$${a}_{0}^{3} {a}_{1}^{( 3 , 1 )} , {a}_{0}^{3} {a}_{1}^{( 3 , 2 )} , {a}_{0}^{3} {a}_{1}^{( 3 , 3 )} , {a}_{0}^{4} {a}_{1}^{( 4 , 1 )} , {a}_{0}^{4} {a}_{1}^{( 4 , 2 )} , and {a}_{0}^{4} {a}_{1}^{( 4 , 3 )} ,$$

(vi) determine costs associated with those trajectories, and/or (vii) determine, based on the determined costs, a base distribution parameter set v_{0,2} and three contingent distributions

$${v}_{1 \vert 0 , 2}^{( 1 )} , {v}_{1 \vert 0 , 2}^{( 2 )} , and {v}_{1 \vert 0 , 2}^{( 3 )} .$$

In the second post-initial iteration (l=3), the system: (i) samples two base controls

$${a}_{0}^{5} and {a}_{0}^{6}$$

based on q₀(a₀|v_{0,2}), (iii) samples three contingent controls

$${a}_{1}^{( 5 , 1 )} , {a}_{1}^{( 5 , 2 )} , and {a}_{1}^{( 5 , 3 )}$$

based on

$${q}_{1 \vert 0}^{( 1 )} ( {a}_{1}^{( 5 , 1 )} \vert {a}_{0}^{5} , {v}_{1 \vert 0 , 2}^{( 1 )} ) , {q}_{1 \vert 0}^{( 2 )} ( {a}_{1}^{( 5 , 2 )} \vert {a}_{0}^{5} , {v}_{1 \vert 0 , 2}^{( 2 )} ) , and {q}_{1 \vert 0}^{( 3 )} ( {a}_{1}^{( 5 , 3 )} \vert {a}_{0}^{3} , {v}_{1 \vert 0 , 2}^{( 3 )} )$$

respectively, (iv) samples three contingent controls

$${a}_{1}^{( 6 , 1 )} , {a}_{1}^{( 6 , 2 )} , and {a}_{1}^{( 6 , 3 )}$$

based on

$${q}_{1 \vert 0}^{( 1 )} ( {a}_{1}^{( 6 , 1 )} \vert {a}_{0}^{6} , {v}_{1 \vert 0 , 2}^{( 1 )} ) , {q}_{1 \vert 0}^{( 2 )} ( {a}_{1}^{( 6 , 2 )} \vert {a}_{0}^{6} , {v}_{1 \vert 0 , 2}^{( 2 )} ) , and {q}_{1 \vert 0}^{( 3 )} ( {a}_{1}^{( 6 , 3 )} \vert {a}_{0}^{6} , {v}_{1 \vert 0 , 2}^{( 3 )} )$$

respectively, (v) determines trajectories

$${a}_{0}^{5} {a}_{1}^{( 5 , 1 )} , {a}_{0}^{5} {a}_{1}^{( 5 , 2 )} , {a}_{0}^{5} {a}_{1}^{( 5 , 3 )} , {a}_{0}^{6} {a}_{1}^{( 6 , 1 )} , {a}_{0}^{6} {a}_{1}^{( 6 , 2 )} , and {a}_{0}^{6} {a}_{1}^{( 6 , 3 )} ,$$

and (vi) determine costs associated with those trajectories. At the end of these three iterations, the system has costs associated with eighteen trajectories. The system may then select the trajectory having the lowest cost to control the vehicle.

As described above, iterative trajectory planning process may include L iterations. In some cases, L is determined based on a predefined value. For example, L may be determined based on an available computational capacity of a vehicle computing device executing the iterative process. Additionally or alternatively, L may be determined based on an available amount of time for determining the trajectory and/or an estimated computational cost associated with each iteration of the iterative trajectory planning process. In some cases, L is determined dynamically, for example based on a convergence condition associated with the iterative process. For example, the system may continue the iterative process until a change between a first set of distribution parameters determined in one iteration and a second set of distribution parameters determined in a subsequent iteration falls below a threshold. As another example, the system may continue the iterative process until a deviation measure (e.g., a covariance and/or a standard deviation) between trajectories sampled during an iteration falls below a threshold. Accordingly, in some cases, the number of iterations may be predetermined, dynamically determined (e.g., based on computational resource constraints, and/or based on convergence criteria), and/or the like.

In some cases, the techniques described herein enhance the safety of a vehicle by enabling a more efficient exploration of a control space within a time constraint (e.g., in real-time and/or near-real-time). The disclosed techniques may enable a vehicle computing device to focus control space exploration on segments of the control space that are more likely to be part of safer maneuvers. This focused exploration may be achieved by iteratively updating a set of probability distributions over the control space based on the costs associated with previously sampled controls. By sampling in accordance with probability distributions focused on lower-cost segments of the control space, the vehicle computing device may efficiently focus its exploration on safer segments of the control space. Accordingly, the techniques described herein may enhance the safety of a vehicle by improving the likelihood of detecting safer trajectories as part of real-time and/or near-real-time vehicle trajectory planning.

In some cases, the techniques described herein enhance the computational efficiency of determining a trajectory for controlling a vehicle by reducing the number of trajectories that need to be evaluated as part of the trajectory planning process. As described above, the disclosed techniques may enable a vehicle computing device to focus control space exploration on segments of the control space that are more likely to be part of lower-cost maneuvers. By focusing the control space search on lower-cost segments of the control space, the disclosed techniques can reduce the number of controls that need to be evaluated to find an optimal trajectory. This reduction in the number of evaluated controls can significantly reduce the computational burden of the trajectory planning process, especially in high-dimensional trajectory spaces where exhaustive search is excessively costly and/or infeasible.

The methods, apparatuses, and systems described herein may be implemented in a number of ways. Example implementations are provided below with reference to the following figures. Although discussed in the context of an autonomous vehicle, in some examples, the methods, apparatuses, and systems described herein may be applied to a variety of systems. In another example, the methods, apparatuses, and systems may be utilized in an aviation or nautical context. Additionally, or alternatively, the techniques described herein may be used with real data (e.g., captured using sensor(s)), simulated data (e.g., generated by a simulator), or any combination thereof.

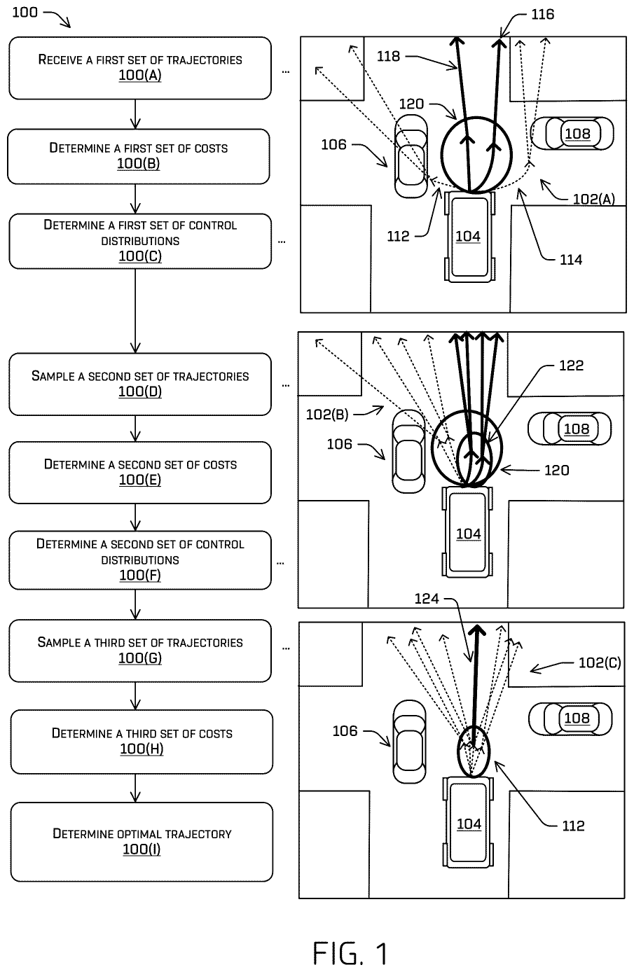

FIG. 1 is a flowchart diagram of an example process 100 for determining an optimal trajectory for controlling a vehicle. As depicted in FIG. 1, at operation 100(A), an example system receives a first set of trajectories. In some cases (e.g., if the operation 100(A) is performed as part of an initial trajectory planning process), the first set of trajectories includes a set of initial trajectories (e.g., as determined using the techniques described above). In some cases (e.g., if the operation 100(A) is performed as part of a post-initial trajectory planning process), the first set of trajectories includes a set of trajectories sampled from a set of control distributions (e.g., generated and/or updated in a preceding trajectory planning iteration). For example, as depicted in FIG. 1, the first set of trajectories 102(A) may include six trajectories for the vehicle 104. These six trajectories include two trajectories associated with the base control 112, two trajectories associated with the base control 114, the trajectory 116, and the trajectory 118.

At operation 100(B), the system determines a first set of costs associated with the first set of trajectories. The first set of costs may, for example, include: (i) base cost(s) for the base control(s) associated with the first set of trajectories, and/or (ii) contingent cost(s) for the contingent control(s) associated with the first set of trajectories. In some cases, the first set of costs may be determined based on whether first set of trajectories intersect with another object in a vehicle's environment and/or the proximity between the first set of trajectories and the object(s) in that environment. Example techniques for determining trajectory-related costs are described above.

For example, as depicted in FIG. 1: (i) the cost(s) for those trajectories associated with the base control 112 may be determined based on the intersection of those trajectories with the object 106, (ii) the cost(s) for those trajectories associated with the base control 114 may be determined based on proximity of those trajectories to the object 108, and/or (iii) the cost(s) associated with the trajectory 116 and the trajectory 118 based on determining that those trajectories do not intersect with and/or do not come within a threshold proximity of the objects in the relevant environment.

At operation 100(C), the system determines a first set of control distributions based on the first set of costs. In some cases, the system: (i) determines a subset of the first set of trajectories based on the first set of costs, and (ii) determines the first set of control distributions based on the determined subset. For example, as depicted in FIG. 1, the system: (i) determines a subset of the first set of trajectories 102(A) that includes the bolded trajectories and excludes the dashed trajectories, and/or (ii) determines a first set of distributions including the base distribution 120 based on the determined subset. Example techniques for determining control distributions based on trajectory-related costs are described above.

At operation 100(D), the system samples a second set of trajectories based on the first set of control distributions. For example, as depicted in FIG. 1, the system samples the second set of trajectories 102(B) based on the first set of distributions including the base distribution 120. Example techniques for sampling trajectories based on control distributions are described above.

At operation 100(E), the system determines a second set of costs associated with the second set of trajectories. For example, as depicted in FIG. 1, the system may determine trajectory-related cost(s) associated with the second set of trajectories 102(B). Example techniques for determining trajectory-related costs are described above.

At operation 100(F), the system determines a second set of control distributions based on the second set of costs. In some cases, the system: (i) determines a subset of the second set of trajectories based on the second set of costs, and (ii) determines the second set of control distributions based on the determined subset. For example, as depicted in FIG. 1, the system: (i) determines a subset of the second set of trajectories 102(B) that includes the bolded trajectories and excludes the dashed trajectories, and/or (ii) determines a second set of distributions including the base distribution 122 based on the determined subset. Example techniques for determining control distributions based on trajectory-related costs are described above.

At operation 100(G), the system samples a third set of trajectories based on the second set of control distributions. For example, as depicted in FIG. 1, the system samples the third set of trajectories 102(C) based on the second set of distributions including the base distribution 122. Example techniques for sampling trajectories based on control distributions are described above.

At operation 100(H), the system determines a third set of costs associated with the third set of trajectories. For example, as depicted in FIG. 1, the system may determine trajectory-related cost(s) associated with the third set of trajectories 102(C). Example techniques for determining trajectory-related costs are described above.

At operation 100(I), the system determines an optimal trajectory (e.g., the bolded trajectory 124) based on the first set of costs, the second set of costs, and/or the third set of costs. In some cases, the system determines a trajectory cost for each trajectory (e.g., each initial trajectory, each sampled trajectory, and/or the like) received, determined, and/or sampled, and determines a trajectory having a lowest cost as the optimal trajectory.

While the example implementation depicted in FIG. 1 is associated with three trajectory planning iterations, a person of ordinary skill in the relevant technology will recognize that an iterative trajectory planning process may include any number of iterations (e.g., L iterations, as described above). Example techniques for determining a number of iterations associated with an iterative trajectory planning process are described above.

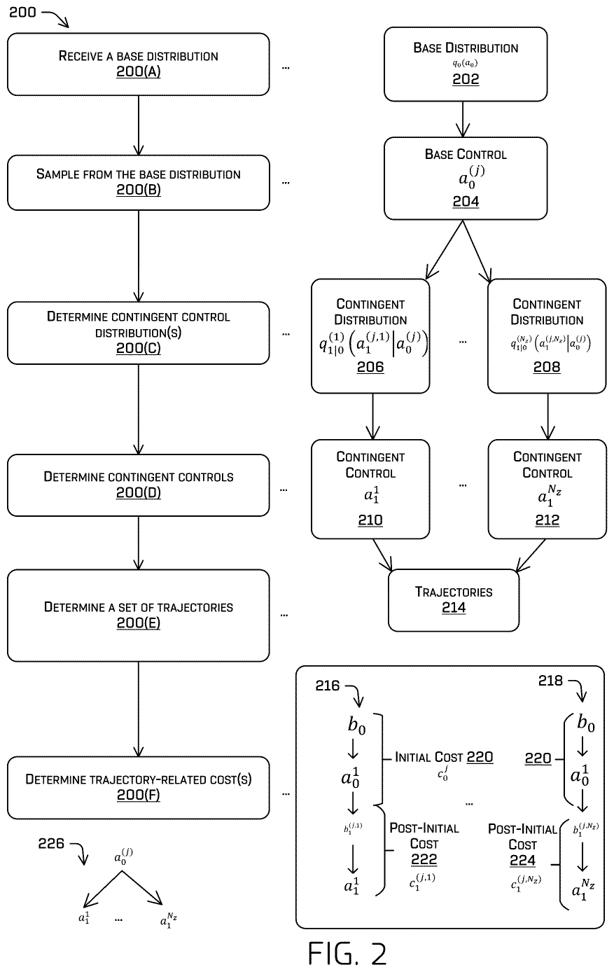

FIG. 2 is a flowchart diagram of an example process 200 for determining trajectory-related cost(s) associated with a set of sampled scenarios. The process 200 may, for example, be performed as part of a trajectory planning iteration in an iterative trajectory planning process, such as part of a post-initial iteration.

As depicted in FIG. 2, at operation 200(A), an example system receives a base distribution. For example, as depicted in FIG. 2, the system receives the base distribution 202, which is denoted as q₀(a₀). In some cases, the base distribution 202 is q₀(a₀|v₀), where a₀ may represent a random variable corresponding to a base control and v₀ may represent parameter(s) of a base distribution as generated by a preceding iteration.

The base distribution may be a control distribution generated by a preceding iteration of the iterative trajectory planning process and/or determined based on a set of received trajectories and associated controls. For example, if the current iteration is the second iteration, the base distribution may be generated by the initial iteration. As another example, if the current iteration is the third iteration, the base distribution may be generated by the second iteration.

At operation 200(B), the system samples a base control from the base distribution. For example, as depicted in FIG. 2, the system samples the base control 204, which is denoted as

$${a}_{0}^{( j )} ,$$

from the base distribution 202. Examples techniques for sampling from a base distribution are described above.

At operation 200(C), the system determines a set of contingent distributions based on the sampled base control. In some cases, each contingent distribution is a distribution of a contingent control as conditioned on: (i) the sampled base control, and/or (ii) parameter(s) of the contingent control distribution, as determined by a preceding iteration. Example techniques for determining contingent distributions are described above.

For example, as depicted in FIG. 2, the system may determine N_{z} contingent distributions based on the base control 204. For example, the N_{z} contingent distributions may include the contingent distribution 206, denoted as

$${q}_{1 \vert 0}^{( 1 )} ( {a}_{1}^{( j , 1 )} \vert {a}_{0}^{( j )} ) , where {a}_{1}^{( j , 1 )}$$

may be a random variable associated with the first contingent control. In some cases,

$${q}_{1 \vert 0}^{( 1 )} ( {a}_{1}^{( j , 1 )} \vert {a}_{0}^{( j )} ) is {q}_{1 \vert 0}^{( 1 )} ( {a}_{1}^{( j , 1 )} \vert {a}_{0}^{( j )} , {v}_{1 \vert 0}^{1} ) , where {v}_{1 \vert 0}^{1}$$

is the set of parameters associated with a first contingent distribution, as determined in a preceding iteration. As another example, the N_{z} contingent distributions may include the N_{z}th contingent distribution 208, denoted

$${q}_{1 \vert 0}^{( {N}_{z} )} ( {a}_{1}^{( j , {N}_{z} )} \vert {a}_{0}^{( j )} ) , where {a}_{1}^{( j , {N}_{z} )}$$

may be a random variable associated with the N_{z}th contingent control. In some cases

$${q}_{1 \vert 0}^{( {N}_{z} )} ( {a}_{1}^{( j , {N}_{z} )} \vert {a}_{0}^{( j )} ) is {q}_{1 \vert 0}^{( {N}_{z} )} ( {a}_{1}^{( j , {N}_{z} )} \vert {a}_{0}^{( {N}_{z} )} , {v}_{1 \vert 0}^{{N}_{z}} ) , where {v}_{1 \vert 0}^{{N}_{z}}$$

is the set of parameters associated with a N_{z}th contingent distribution, as determined in a preceding iteration.

At operation 200(D), the system samples a set of N_{z} contingent controls based on the N_{z} contingent distributions. For example, as depicted in FIG. 1, the system map sample the contingent control 210, denoted as

$${a}_{1}^{( j , 1 )} ,$$

from the contingent distribution 206 and the contingent control 212, denoted as

$${a}_{1}^{( j , {N}_{z} )} ,$$

from the contingent distribution 208. Example techniques for determining contingent controls based on sampling from the contingent distributions are described above.

At operation 200(E), the system determines a set of N_{z} trajectories 214 based on the sampled base control and the sampled N_{z} contingent controls. Each trajectory may include the base control and a respective one of the N_{z} contingent controls. For example, as depicted in FIG. 2, the system may determine a trajectory 216 including

$${a}_{0}^{( j )} and {a}_{1}^{( j , 1 )}$$

(e.g., a trajectory starting with

$${a}_{0}^{( j )}$$

and including H−1 instances of

$${a}_{1}^{( j , 1 )} )$$

and a trajectory 218 including

$${a}_{0}^{( j )} and {a}_{1}^{( j , {N}_{z} )}$$

(e.g., a trajectory starting with

$${a}_{0}^{( j )}$$

and including H−1 instances of

$${a}_{1}^{( j , {N}_{z} )} ) .$$

As depicted, the set of N_{z} trajectories associated with (e.g., conditioned on) base control

$${a}_{0}^{( j )}$$

may be represented using the tree structure 226. In the tree structure 226, the root node corresponds to the base control while leaf and/or branch nodes may correspond to the N_{z} contingent controls. For example, in some cases, each branch of the tree structure 226 corresponds to one of the N_{z} contingent controls.

At operation 200(F), the system determines a set of trajectory-related costs based on the N_{z} trajectories. The set of trajectory-related costs may include base cost(s) associated with base control(s) and/or contingent cost(s) associated with trajectories. A base cost may be determined based on an initial cost associated with a base control and post-initial costs associated with a set of contingent costs that are contingent on that base control. A contingent cost may be determined based on an initial cost and a post-initial cost associated with a trajectory's base control and contingent control, respectively. Example techniques for determining initial costs, post-initial costs, base costs, and contingent costs are described below.

For example, as depicted in FIG. 2, the system may determine the initial cost 220, denoted as

$${c}_{0}^{j} ,$$

associated with

$${a}_{0}^{( j )} .$$

The initial cost 220 may be a cost associated with executing

$${a}_{0}^{( j )}$$

at an initial time (e.g., a time t₀). Additionally or alternatively, the system may determine the post-initial cost 222, denoted as

$${c}_{1}^{( j , 1 )} ,$$

associated with

$${a}_{1}^{( j , 1 )} .$$

Post-initial cost 222 may be a cost associated with executing

$${a}_{1}^{( j , 1 )}$$

at one or more post-initial times (e.g., at H−1 post-initial times after the initial time). Additionally or alternatively, the system may determine the post-initial cost 224, denoted as

$${c}_{1}^{( j , {N}_{z} )} ,$$

associated with

$${a}_{1}^{( j , {N}_{z} )} .$$

Post-initial cost 224 may be a cost associated with executing

$${a}_{1}^{( j , {N}_{z} )}$$

at one or more post-initial times (e.g., at H−1 post-initial times after the initial time).

In some cases, the system determines a base cost based on a base control's initial cost and N_{z} post-initial costs associated with N_{z} contingent controls that are contingent on that base control. For example, in some cases, the system may determine a base control associated with based on the initial cost 220 and N_{z} post-initial costs associated with N_{z} contingent controls that are contingent on that base control, including post-initial cost 222 and post-initial cost 224.

In some cases, the system determines a contingent cost associated with a trajectory based on the initial cost for the trajectory's base control and the post-initial cost for the trajectory's contingent control. For example, in some cases, the system may determine a contingent control associated with the trajectory 216 based on the initial cost 220 and the post-initial cost 222. As another example, in some cases, the system may determine a contingent control associated with the trajectory 218 based on the initial cost 220 and the post-initial cost 224.

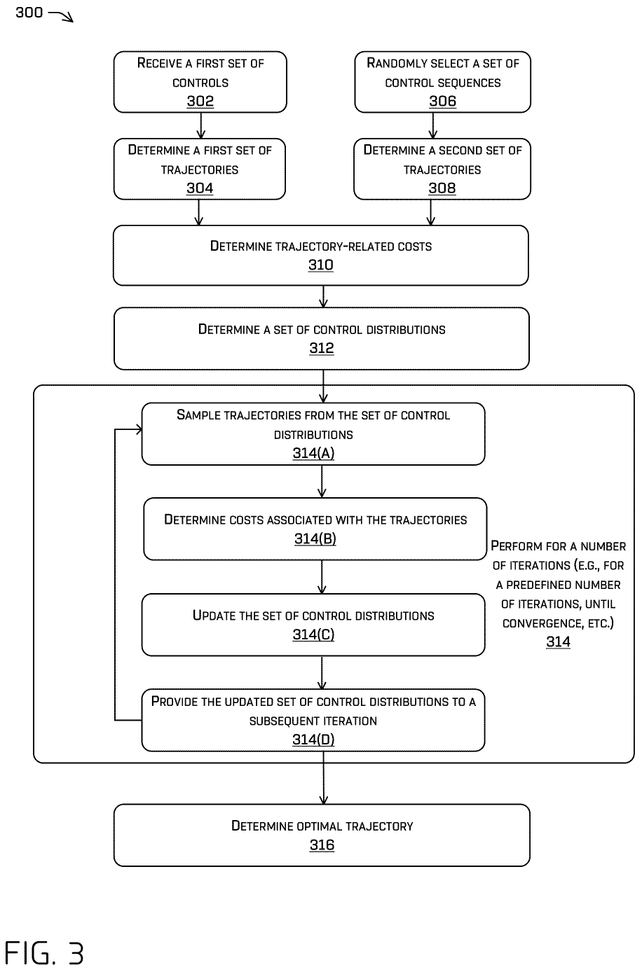

FIG. 3 is a flowchart diagram of an example process 300 for determining an optimal vehicle trajectory based on an iterative trajectory planning process. As depicted in FIG. 3, at operation 302, the system receives a first set of controls (e.g., reference controls). The first set of controls may, for example, be a predetermined set of controls. The predetermined controls may be determined based on a detected state of the vehicle's environment. Example techniques for generating predetermined controls based on detected environment states are described above.

At operation 304, the system determines a first set of trajectories based on the first set of controls. In some cases, each trajectory may include a number of instances (e.g., H instances) of one of the first set of controls. For example, if a predetermined control includes driving at a first steering angle at first velocity, a trajectory may include repeatedly (e.g., for H times) driving at the first steering angle and at the first velocity.

At operation 306, the system randomly selects a set of control sequences based on a control space. In some cases, each randomly selected control sequence may include H controls, where each of the H controls may be determined by a randomly selecting a multi-dimensional control space. Examples of multi-dimensional control spaces and example techniques for determining randomly selected control sequences are described above. In some cases, randomly sampling the multi-dimensional control space is based on (e.g., from) a control distribution (e.g., uniform) and/or based on a predefined and/or predetermined control distribution. For example, in some cases, the system may randomly sample from a control distribution at a previous time (e.g., during a previous trajectory determination iteration and/or operation associated with a preceding).

At operation 308, the system determines a second set of trajectories based on the randomly selected control sequences. For example, each trajectory in the second set may include a randomly selected control sequence. Example techniques for determining trajectories based on randomly selected control sequences are described above.

At operation 310, the system determines a set of trajectory-related costs based on the first set of trajectories and the second set of trajectories. In some cases, the system determines a set of costs associated with each trajectory in the first set and/or the second set. The cost(s) associated with a trajectory may be determined based on one or more of a collision cost, a safety cost, a path progression cost, a steering cost, a travel time cost, an acceleration cost, a lane position cost, and/or a comfort cost. Example techniques for determining costs associated with trajectories are described above.

At operation 312, the system determines a set of control distributions based on the set of trajectory-related costs. The set of control distributions may include a base distribution associated with base controls and one or more contingent distributions associated with contingent controls. In some cases, the system determines the control distributions by determining parameters of the distributions that increase a likelihood of the controls associated with lower-cost trajectories. Example techniques for determining control distributions (e.g., base and/or contingent distributions) based on trajectory-related costs are described above.

At operation 314, the system performs a set of iterations (e.g., L−1 iterations) of the operations 314(A)-314(D). At operation 314(A), the system samples a set of trajectories from the set of control distributions (e.g., determined at operation 312 for the first iteration and/or at operation 314(D) for any subsequent iteration). In some cases, the system samples each trajectory by sampling a base control from the base distribution and/or one or more contingent controls from one or more contingent distributions. Example techniques for sampling trajectories from control distributions are described above.

At operation 314(B), the system determines costs associated with the trajectories sampled at operation 314(A). In some cases, the system determines the costs using techniques similar to those described above, for example in relation to operation 310.

At operation 314(C), the system updates the set of control distributions based on the costs determined at operation 314(B). In some cases, the system updates the control distributions by determining parameters of the distributions that increase a likelihood of the controls associated with lower-cost trajectories sampled at operation 314(A). Example techniques for updating control distributions based on trajectory-related costs are described above.

At operation 314(D), the system provides the updated set of control distributions to a subsequent iteration of the process 300. The subsequent iteration may then sample a new set of trajectories from the updated control distributions and determine costs associated with the newly sampled trajectories. The process 300 may continue iterating until a convergence condition is reached and/or until a predefined number of iterations have been performed.

At operation 316, the system determines an optimal trajectory based on the trajectories evaluated over the various iterations of the process 300. In some cases, the system determines the optimal trajectory by selecting the trajectory with the lowest cost from among all trajectories evaluated during the process 300. Example techniques for determining an optimal trajectory based on iteratively evaluated trajectories are described above.

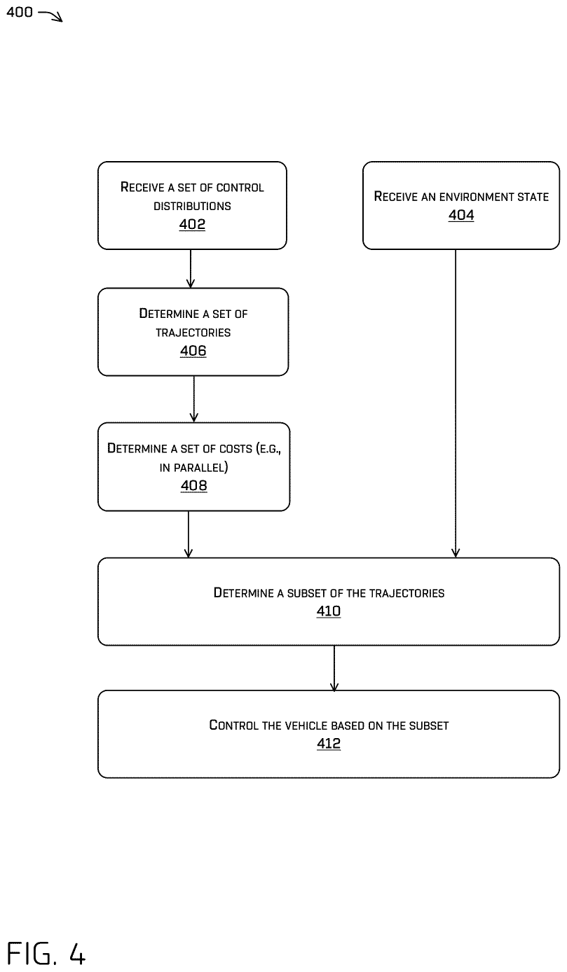

FIG. 4 is a flowchart diagram of an example process 400 for controlling a vehicle based on a selected trajectory. As depicted in FIG. 4, at operation 402, the system receives a set of control distributions. The set of control distributions may be generated by a prior iteration of an iterative trajectory planning process, such as the process 300 described above in relation to FIG. 3. In some cases, the set of control distributions includes a base distribution defined over potential base controls and/or one or more contingent distributions each defined over potential contingent controls conditioned on a particular base control. The base distribution and contingent distributions may be defined by a set of parameters (e.g., means and covariances) that specify the shape and/or concentration of the probability density over the control space. Example techniques for generating and/or updating control distributions are described above.

At operation 404, the system receives an environment state. The environment state may represent a state of the vehicle's environment at one or more times. In some cases, the environment state is determined based on sensor data received from one or more sensors of the vehicle (e.g., cameras, lidar sensors, radar sensors, and/or ultrasonic sensors). The environment state may represent positions, velocities, accelerations, headings, and/or other attributes of one or more objects in the vehicle's environment. In some cases, the environment state represents the state of the environment at a time associated with controlling the vehicle (e.g., a current time or a time in the near future).

At operation 406, the system determines a set of trajectories based on the set of control distributions. In some cases, the system determines the set of trajectories by sampling from the control distributions. For example, the system may sample a base control from the base distribution and one or more contingent controls from the contingent distribution(s) conditioned on the sampled base control. The system may then generate a set of trajectories each including the sampled base control and a respective one of the contingent controls.

At operation 408, the system determines a set of costs associated with the set of trajectories based on the environment state. In some cases, the system determines the costs by simulating the trajectories in the context of the environment state and evaluating the simulated outcomes. For example, the system may predict future states of the vehicle and/or other objects in the environment assuming the vehicle follows each trajectory and evaluate the predicted states against a set of cost functions. Example techniques for determining costs associated with trajectories are described in U.S. Pat. No. 11,161,502, entitled “Cost-Based Path Determination” and filed on Aug. 13, 2019, and in U.S. Pat. No. 11,360,477, entitled “Trajectory Generation using Temporal Logic and Tree Search” and filed on Jun. 22, 2020, both of which are incorporated by reference herein in entirety and for all purposes.

At operation 410, the system determines a subset of the trajectories based on the set of costs. In some cases, the system selects a predefined number and/or ratio of trajectories with the lowest costs. In some cases, the system selects the trajectories that satisfy a set of cost criteria (e.g., trajectories with a collision cost below a threshold, a safety cost above a threshold, and/or a comfort cost below a threshold). Example techniques for selecting a subset of trajectories based on trajectory-related costs are described above.

At operation 412, the system controls the vehicle based on the subset of trajectories. In some cases, the system updates the set of control distributions based on the determined subset (e.g., using the techniques described above). The system then samples a set of controls based on the updated set of control distributions (e.g., using the techniques described above). The system then determines an optimal trajectory based on the sampled controls based on the updated set of control distributions. The system may then control the vehicle based on the optimal trajectory (e.g., using the techniques described above).

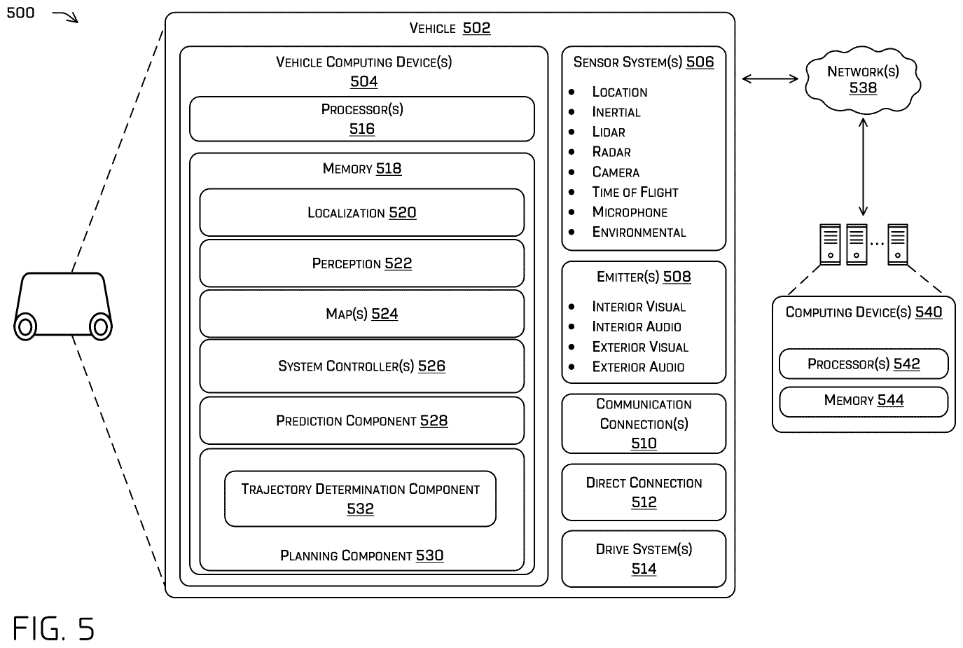

FIG. 5 depicts a block diagram of an example system 500 for implementing various techniques described herein. In some instances, the example system 500 may include vehicle 502 and one or more computing devices 540. In some instances, the vehicle 502 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 502 may be a fully or partially autonomous vehicle having any other level or classification. Moreover, in some instances, the techniques described herein may be usable by non-autonomous vehicles as well. These are merely examples, and the systems and methods described herein also may be incorporated into any ground-borne, airborne, or waterborne vehicle, including those ranging from vehicles that need to be manually controlled by a driver at all times, to those that are partially or fully autonomously controlled.

The vehicle 502 may include vehicle computing device(s) 504, sensor(s) 506, emitter(s) 508, network interface(s) 510, at least one direct connection 512 (e.g., for physically coupling with the vehicle to exchange data and/or to provide power), and one or more drive system(s) 514. The system 500 may additionally or alternatively comprise vehicle computing device(s) 504.

In some instances, the sensor(s) 506 may include lidar sensors, radar sensors, ultrasonic transducers, sonar sensors, location sensors (e.g., global positioning system (GPS), compass), inertial sensors (e.g., inertial measurement units (IMUs), accelerometers, magnetometers, gyroscopes), image sensors (e.g., red-green-blue (RGB), infrared (IR), intensity, depth, time of flight cameras, etc.), microphones, wheel encoders, environment sensors (e.g., thermometer, hygrometer, light sensors, pressure sensors), etc.

The vehicle 502 may also include emitter(s) 508 for emitting light and/or sound, as described above. The vehicle 502 may also include network interface(s) 510 that enable communication between the vehicle 502 and one or more other local or remote computing device(s). The network interface(s) 510 may include physical and/or logical interfaces for connecting the vehicle computing device(s) 504 to another computing device or a network, such as network(s) 538.

In some instances, the vehicle 502 may include one or more drive systems(s) 514 (or drive components). In some instances, the vehicle 502 may have a single drive system 514. In some instances, the drive system(s) 514 may include one or more sensors to detect conditions of the drive system(s) 514 and/or the surroundings of the vehicle 502. By way of example and not limitation, the sensor(s) of the drive systems(s) 514 may include one or more wheel encoders (e.g., rotary encoders) to sense rotation of the wheels of the drive components, inertial sensors (e.g., inertial measurement units, accelerometers, gyroscopes, magnetometers) to measure orientation and acceleration of the drive component, cameras or other image sensors, ultrasonic sensors to acoustically detect objects in the surroundings of the drive component, lidar sensors, radar sensors, etc. Some sensors, such as the wheel encoders may be unique to the drive system(s) 514. In some cases, the sensor(s) on the drive system(s) 514 may overlap or supplement corresponding systems of the vehicle 502 (e.g., sensor(s) 506).

The drive systems(s) 514 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.).

The vehicle computing device(s) 504 may include processor(s) 516 and memory 518 communicatively coupled with the one or more processors 516. Computing device(s) 540 may also include processor(s) 542, and/or memory 544.

The processor(s) 516 and/or 542 may be any suitable processor capable of executing instructions (e.g., computer-executable instructions) to process data and perform operations as described herein. By way of example and not limitation, the processor(s) 516 and/or 542 may comprise one or more central processing units (CPUs), graphics processing units (GPUs), integrated circuits (e.g., application-specific integrated circuits (ASICs)), gate arrays (e.g., field-programmable gate arrays (FPGAs)), and/or any other device or portion of a device that processes electronic data to transform that electronic data into other electronic data that may be stored in registers and/or memory.

Memory 518 and/or 544 may be examples of non-transitory computer-readable media. Memory 518 and/or 544 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, memory 518 and/or memory 544 may store a localization component 520, perception component 522, maps 524, system controller(s) 526, prediction component 528, and/or planning component 530.

In at least one example, the localization component 520 may include hardware and/or software to receive data from the sensor(s) 506 to determine a position, velocity, and/or orientation of the vehicle 502 (e.g., one or more of an x-, y-, z-position, roll, pitch, or yaw).

Memory 518 may further include one or more maps 524 that may be used by the vehicle 502 to navigate within the environment. For the purpose of this discussion, a map may be any number of data structures modeled in two dimensions, three dimensions, or N-dimensions that may provide information about an environment, such as, but not limited to, topologies (such as intersections), streets, mountain ranges, roads, terrain, and the environment in general. In one example, a map may include a three-dimensional mesh generated using the techniques discussed herein. In some instances, the map may be stored in a tiled format, such that individual tiles of the map represent a discrete portion of an environment and may be loaded into working memory as needed. In at least one example, the one or more maps 524 may include at least one map (e.g., images and/or a mesh) generated in accordance with the techniques discussed herein. In some examples, the vehicle 502 may be controlled based at least in part on the maps 524. That is, the maps 524 may be used in connection with the localization component 520, the perception component 522, and/or the planning component 530 to determine a location of the vehicle 502, identify objects in an environment, and/or generate routes and/or trajectories to navigate within an environment.

In some instances, the perception component 522 may comprise a primary perception system and/or a prediction system implemented in hardware and/or software. In some examples, sensor data and/or perception data may be used to generate an environment state that represents a current state of the environment. For example, the environment state may be a data structure that identifies object data (e.g., object position, area of environment occupied by object, object heading, object velocity, historical object data), environment layout data (e.g., a map or sensor-generated layout of the environment), environment condition data (e.g., the location and/or area associated with environmental features, such as standing water or ice, whether it's raining, visibility metric), sensor data (e.g., an image, point cloud), etc. In some examples, the environment state may include a top-down two-dimensional representation of the environment and/or a three-dimensional representation of the environment, either of which may be augmented with object data. In yet another example, the environment state may include sensor data alone. In yet another example, the environment state may include sensor data and perception data together.

Prediction component 528 may include functionality to generate predicted information associated with objects in an environment.

Planning component 530 may receive a location and/or orientation of the vehicle 502 from the localization component 520, perception data from the perception component 522, and/or predicted trajectories from the prediction component 528 and may determine instructions for controlling operation of the vehicle 502 based at least in part on any of this data.

Planning component 530 may include a trajectory determination component 532 configured to determine an optimal trajectory for the vehicle 502, for example using the techniques described herein (e.g., in relation to FIGS. 1-4).

Memory 518 and/or 544 may additionally or alternatively store a mapping system (e.g., generating a map based at least in part on sensor data), a planning system, a ride management system, etc. Although localization component 520, perception component 522, the prediction component 528, the planning component 530, and/or system controller(s) 526 are illustrated as being stored in memory 518, any of these components may include processor-executable instructions, machine-learned model(s) (e.g., a neural network), and/or hardware and all or part of any of these components may be stored on memory 544 or configured as part of computing device(s) 540.

As described herein, the localization component 520, the perception component 522, the prediction component 528, the planning component 530, and/or other components of the system 500 may comprise one or more ML models. For example, the localization component 520, the perception component 522, the prediction component 528, and/or the planning component 530 may each comprise different ML model pipelines. The prediction component 528 may use a different ML model or a combination of different ML models in different circumstances. For example, the prediction component 528 may use different GNNs, RNNs, CNNs, MLPs and/or other neural networks tailored to outputting predicted object trajectories in different seasons (e.g., summer or winter), different driving conditions and/or visibility conditions (e.g., times when border lines between road lanes may not be clear or may be covered by snow), and/or based on different crowd or traffic conditions (e.g., more conservative trajectories in a crowded traffic conditions such as downtown areas, etc.). In various examples, any or all the above ML models may comprise an attention mechanism, GNN, and/or any other neural network. An exemplary neural network is a biologically inspired algorithm which passes input data through a series of connected layers to produce an output. Each layer in a neural network may also comprise another neural network or may comprise any number of layers (whether convolutional or not). As may be understood in the context of this disclosure, a neural network may utilize machine-learning, which may refer to a broad class of such algorithms in which an output is generated based on learned parameters.

Although discussed in the context of neural networks, any type of machine-learning may be used consistent with this disclosure. For example, machine-learning algorithms may include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-50, ResNet-101, VGG, DenseNet, PointNet, and the like.

Memory 518 may additionally or alternatively store one or more system controller(s) 526, which may be configured to control steering, propulsion, braking, safety, emitters, communication, and other systems of the vehicle 502. These system controller(s) 526 may communicate with and/or control corresponding systems of the drive systems(s) 514 and/or other components of the vehicle 502.

In an additional or alternate example, vehicle 502 and/or computing device(s) 540 may communicate (e.g., transmit and/or receive messages over network(s) 538) with one or more passenger devices (not shown). A passenger device may include, for example, a smart phone, portable computer such as a laptop or tablet, wearable device (e.g., smart glasses, smart watch, earpiece), and/or the like. Although a passenger device may be a device associated with a passenger that is discrete from device(s) of the autonomous vehicle, it is contemplated that the passenger device may be a sub-system and/or a device of the vehicle 502. For example, the passenger device may additionally or alternatively comprise a display and/or one or more input/output devices, such as a touchscreen, microphone, speaker, and/or the like. In some examples, the vehicle 502 may transmit messages and/or receive messages from the passenger device.

It should be noted that while FIG. 5 is illustrated as a distributed system, in alternative examples, components of the vehicle 502 may be associated with the computing device(s) 540 and/or components of the computing device(s) 540 may be associated with the vehicle 502. That is, the vehicle 502 may perform one or more of the functions associated with the computing device(s) 540, and vice versa.

### CONCLUSION

While one or more examples of the techniques described herein have been described, various alterations, additions, permutations, and equivalents thereof are included within the scope of the techniques described herein. As can be understood, the components discussed herein are described as divided for illustrative purposes. However, the operations performed by the various components can be combined or performed in any other component. It should also be understood that components or steps discussed with respect to one example or implementation may be used in conjunction with components or steps of other examples. For example, the components and instructions of FIG. 5 may utilize the processes and flows of FIGS. 1-4.

A non-limiting list of objects may include obstacles in an environment, including but not limited to pedestrians, animals, cyclists, trucks, motorcycles, other vehicles, or the like. Such objects in the environment have a “geometric pose” (which may also be referred to herein as merely “pose”) comprising a location and/or orientation of the overall object relative to a frame of reference. In some examples, pose may be indicative of a position of an object (e.g., pedestrian), an orientation of the object, or relative appendage positions of the object. Geometric pose may be described in two-dimensions (e.g., using an x-y coordinate system) or three-dimensions (e.g., using an x-y-z or polar coordinate system), and may include an orientation (e.g., roll, pitch, and/or yaw) of the object. Some objects, such as pedestrians and animals, also have what is referred to herein as “appearance pose.” Appearance pose comprises a shape and/or positioning of parts of a body (e.g., appendages, head, torso, eyes, hands, feet, etc.). As used herein, the term “pose” refers to both the “geometric pose” of an object relative to a frame of reference and, in the case of pedestrians, animals, and other objects capable of changing shape and/or positioning of parts of a body, “appearance pose.” In some examples, the frame of reference is described with reference to a two- or three-dimensional coordinate system or map that describes the location of objects relative to a vehicle. However, in other examples, other frames of reference may be used.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

### EXAMPLE CLAUSES

While the example clauses described below are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

A: A system comprising: one or more processors; and one or more non-transitory computer-readable media storing computer-executable instructions that, when executed, cause the system to perform operations comprising: determining, based on a first distribution of controls, a first set of trajectories, a trajectory of the first set of trajectories comprising a sequence of controls for controlling an autonomous vehicle to traverse an environment; determining a set of costs associated with the first set of trajectories; determining, based at least in part on the set of costs, a subset of the first set of trajectories; determining a second distribution of controls based on the subset; and controlling the autonomous vehicle based on the second distribution of controls.

B: The system of paragraph A, wherein: the sequence of controls comprise a first control and a second control associated with executing the first control and detecting a first state of the environment; and determining the sequence of controls comprises: determining the first control based on sampling the first distribution of controls; and determining the second control based on sampling a third distribution of controls, the third distribution of controls being associated with executing the first control and detecting the first state.

C: The system of paragraph B, wherein determining the first set of trajectories comprises: determining a third control based on sampling a fourth distribution of controls, the fourth distribution of controls being associated with executing the first control and detecting a second state of the environment; determining a second sequence of controls comprising the first control and the third control; and determining a second trajectory of the first set of trajectories, the second trajectory comprising the second sequence of controls.

D: The system of any of paragraphs A-C, wherein controlling the autonomous vehicle comprises: determining, based on the second distribution of controls, a second set of trajectories; determining a second set of costs associated with the second set of trajectories; determining a target trajectory based at least in part on the set of costs and the second set of costs; and controlling the autonomous vehicle based at least in part on the target trajectory.

E: The system of any of paragraphs A-D, wherein the first distribution of controls is determined based on a second trajectory comprising a second sequence of controls, the second sequence of controls being associated with one or more of: a predefined trajectory; or a second control determined based on random sampling from a multi-dimensional control space.

F: One or more non-transitory computer-readable media storing instructions executable by one or more processors, wherein the instructions, when executed, cause the one or more processors to perform operations comprising: determining, based on a first distribution of controls, a trajectory comprising a sequence of controls for controlling a vehicle traversing through an environment; determining a cost associated with the trajectory; determining a second distribution of controls based on the cost; and controlling the vehicle based on the second distribution of controls.

G: The one or more non-transitory computer-readable media of paragraph F, wherein determining the cost comprises: determining a first cost associated with executing a first control in the sequence of controls based on detecting a first state of the environment; determining a second cost associated with executing a second control in the sequence of controls after executing the first control; and determining the cost based on the first cost and the second cost.

H: The one or more non-transitory computer-readable media of paragraph G, wherein: the trajectory is one of a set of trajectories, the cost is one of a set of costs, and determining the second distribution of controls comprises: determining, based on the set of costs, a subset of the set of trajectories; and determining the second distribution of controls based on the subset.

I: The one or more non-transitory computer-readable media of paragraph H, the set of trajectories are determined substantially simultaneously.

J: The one or more non-transitory computer-readable media of paragraph H or I, wherein determining the subset of the set of trajectories comprises determining a ratio of trajectories associated with lowest costs in the set of costs.

K: The one or more non-transitory computer-readable media of any of paragraphs F-J, the operations further comprising: determining, based on the first distribution of controls, a set of trajectories comprising the trajectory and a second trajectory; determining, based at least in part on determining that a second cost associated with the second trajectory exceeds the cost, a first weight associated with the trajectory and a second weight associated with the second trajectory, the first weight exceeding the second weight; and determining the second distribution of controls based on the first weight and the second weight.

L: The one or more non-transitory computer-readable media of any of paragraphs F-K, wherein the first distribution of controls is determined based on a first set of trajectories, and controlling the vehicle comprises: determining, based on the first distribution of controls, a second set of trajectories comprising the first set of trajectories; and controlling the vehicle based on a lowest-cost trajectory from the first set of trajectories and the second set of trajectories.

M: The one or more non-transitory computer-readable media of any of paragraphs F-L, wherein the first distribution of controls is determined based on a second trajectory comprising a second sequence of controls, the second sequence of controls being associated with one or more of: executing a first control at a plurality of control points; or a second control determined based on random sampling from a multi-dimensional control space.

N: A method comprising: determining, based on a first distribution of controls, a trajectory comprising a sequence of controls for controlling a vehicle traversing through an environment; determining a cost associated with the trajectory; determining a second distribution of controls based on the cost; and controlling the vehicle based on the second distribution of controls.

O: The method of paragraph N, wherein determining the cost comprises: determining a first cost associated with executing a first control in the sequence of controls based on detecting a first state of the environment; determining a second cost associated with executing a second control in the sequence of controls after executing the first control; and determining the cost based on the first cost and the second cost.

P: The method of paragraph O, wherein: the trajectory is one of a set of trajectories, the cost is one of a set of costs, and determining the second distribution of controls comprises: determining, based on the set of costs, a subset of the set of trajectories; and determining the second distribution of controls based on the subset.

Q: The method of paragraph P, the set of trajectories are determined substantially simultaneously.

R: The method of paragraph P or Q, further comprising: determining, based on the first distribution of controls, a set of trajectories comprising the trajectory and a second trajectory; determining, based at least in part on determining that a second cost associated with the second trajectory exceeds the cost, a subset of the set of trajectories, the subset comprising the trajectory and excluding the second trajectory; and determining the second distribution of controls based on the subset.

S: The method of paragraph Q, wherein determining the subset of the set of trajectories comprises determining a ratio of trajectories associated with lowest costs in the set of costs.

T: The method of any of paragraphs N-S, further comprising: determining, based on the first distribution of controls, a set of trajectories comprising the trajectory and a second trajectory; determining, based at least in part on determining that a second cost associated with the second trajectory exceeds the cost, a first weight associated with the trajectory and a second weight associated with the second trajectory, the first weight exceeding the second weight; and determining the second distribution of controls based on the first weight and the second weight.

What is claimed is:

1. A system comprising:
one or more processors; and
one or more non-transitory computer-readable media storing computer-executable instructions that, when executed, cause the system to perform operations comprising:
determining, based on a first distribution of controls, a first set of trajectories, a trajectory of the first set of trajectories comprising a sequence of controls for controlling an autonomous vehicle to traverse an environment;
determining a set of costs associated with the first set of trajectories;
determining, based at least in part on the set of costs, a subset of the first set of trajectories;
determining a second distribution of controls based on the subset; and
controlling the autonomous vehicle based on the second distribution of controls.

2. The system of claim 1, wherein:
the sequence of controls comprise a first control and a second control associated with executing the first control and detecting a first state of the environment; and
determining the sequence of controls comprises:
determining the first control based on sampling the first distribution of controls; and
determining the second control based on sampling a third distribution of controls, the third distribution of controls being associated with executing the first control and detecting the first state.

3. The system of claim 2, wherein determining the first set of trajectories comprises:
determining a third control based on sampling a fourth distribution of controls, the fourth distribution of controls being associated with executing the first control and detecting a second state of the environment;
determining a second sequence of controls comprising the first control and the third control; and
determining a second trajectory of the first set of trajectories, the second trajectory comprising the second sequence of controls.

4. The system of claim 1, wherein controlling the autonomous vehicle comprises:
determining, based on the second distribution of controls, a second set of trajectories;
determining a second set of costs associated with the second set of trajectories;
determining a target trajectory based at least in part on the set of costs and the second set of costs; and
controlling the autonomous vehicle based at least in part on the target trajectory.

5. The system of claim 1, wherein the first distribution of controls is determined based on a second trajectory comprising a second sequence of controls, the second sequence of controls being associated with one or more of:
a predefined trajectory; or
a second control determined based on random sampling from a multi-dimensional control space.

6. One or more non-transitory computer-readable media storing instructions executable by one or more processors, wherein the instructions, when executed, cause the one or more processors to perform operations comprising:
determining, based on a first distribution of controls, a trajectory comprising a sequence of controls for controlling a vehicle traversing through an environment;
determining a cost associated with the trajectory;
determining a second distribution of controls based on the cost; and
controlling the vehicle based on the second distribution of controls.

7. The one or more non-transitory computer-readable media of claim 6, wherein determining the cost comprises:
determining a first cost associated with executing a first control in the sequence of controls based on detecting a first state of the environment;
determining a second cost associated with executing a second control in the sequence of controls after executing the first control; and
determining the cost based on the first cost and the second cost.

8. The one or more non-transitory computer-readable media of claim 7, wherein:
the trajectory is one of a set of trajectories,
the cost is one of a set of costs, and
determining the second distribution of controls comprises:
determining, based on the set of costs, a subset of the set of trajectories; and
determining the second distribution of controls based on the subset.

9. The one or more non-transitory computer-readable media of claim 8, the set of trajectories are determined substantially simultaneously.

10. The one or more non-transitory computer-readable media of claim 8, wherein determining the subset of the set of trajectories comprises determining a ratio of trajectories associated with lowest costs in the set of costs.

11. The one or more non-transitory computer-readable media of claim 6, the operations further comprising:
determining, based on the first distribution of controls, a set of trajectories comprising the trajectory and a second trajectory;
determining, based at least in part on determining that a second cost associated with the second trajectory exceeds the cost, a first weight associated with the trajectory and a second weight associated with the second trajectory, the first weight exceeding the second weight; and
determining the second distribution of controls based on the first weight and the second weight.

12. The one or more non-transitory computer-readable media of claim 6, wherein the first distribution of controls is determined based on a first set of trajectories, and controlling the vehicle comprises:
determining, based on the first distribution of controls, a second set of trajectories comprising the first set of trajectories; and
controlling the vehicle based on a lowest-cost trajectory from the first set of trajectories and the second set of trajectories.

13. The one or more non-transitory computer-readable media of claim 6, wherein the first distribution of controls is determined based on a second trajectory comprising a second sequence of controls, the second sequence of controls being associated with one or more of:
executing a first control at a plurality of control points; or
a second control determined based on random sampling from a multi-dimensional control space.

14. A method comprising:
determining, based on a first distribution of controls, a trajectory comprising a sequence of controls for controlling a vehicle traversing through an environment;
determining a cost associated with the trajectory;
determining a second distribution of controls based on the cost; and
controlling the vehicle based on the second distribution of controls.

15. The method of claim 14, wherein determining the cost comprises:
determining a first cost associated with executing a first control in the sequence of controls based on detecting a first state of the environment;
determining a second cost associated with executing a second control in the sequence of controls after executing the first control; and
determining the cost based on the first cost and the second cost.

16. The method of claim 15, wherein:
the trajectory is one of a set of trajectories,
the cost is one of a set of costs, and
determining the second distribution of controls comprises:
determining, based on the set of costs, a subset of the set of trajectories; and
determining the second distribution of controls based on the subset.

17. The method of claim 16, the set of trajectories are determined substantially simultaneously.

18. The method of claim 16, further comprising:
determining, based on the first distribution of controls, a set of trajectories comprising the trajectory and a second trajectory;
determining, based at least in part on determining that a second cost associated with the second trajectory exceeds the cost, a subset of the set of trajectories, the subset comprising the trajectory and excluding the second trajectory; and
determining the second distribution of controls based on the subset.

19. The method of claim 17, wherein determining the subset of the set of trajectories comprises determining a ratio of trajectories associated with lowest costs in the set of costs.

20. The method of claim 14, further comprising:
determining, based on the first distribution of controls, a set of trajectories comprising the trajectory and a second trajectory;
determining, based at least in part on determining that a second cost associated with the second trajectory exceeds the cost, a first weight associated with the trajectory and a second weight associated with the second trajectory, the first weight exceeding the second weight; and
determining the second distribution of controls based on the first weight and the second weight.
